(19) United States
(12) Patent Application Publication
(10) Pub. No.: US 2007/0209484 A1
(43) Pub. Date: Sep. 13, 2007

(54) LOCKING PLIERS

(76) Inventors: Thomas M. Chervenak, Beatrice, NE (US); Brett Lucus, Huntersville, NC (US)

Correspondence Address: MOORE & VAN ALLEN PLLC, P.O. BOX 13706, Research Triangle Park, NC, 27709, US

(21) Appl. No.: 11/308,211

(22) Filed: Mar. 13, 2006

(51) Int. Cl. B25B 7/12

(52) U.S. Cl. 81/368

(57) ABSTRACT

The locking pliers comprise a first handle connected to a fixed jaw. A second handle and second jaw are pivotable relative to the first handle and first jaw such that relative movement of the handles causes the jaws to open and close. A toggle-locking mechanism locks the jaws in the closed position. An adjustment screw is provided to vary the effective length of the toggle locking mechanism to control the distance between the jaws in the closed position and to thereby control the force applied by the jaws. The adjustment screw comprises a head that has a knurled outer periphery that can be manually manipulated. A socket is formed in the transverse face of the screw head that is disposed along the longitudinal rotational axis of the screw. The socket has an internal configuration that receives a torque applying tool.

### BACKGROUND

This invention relates generally to locking pliers and, more particularly, to an improved adjustment mechanism for such pliers.

Pliers-type hand tools with toggle-locking mechanisms are generally known as locking pliers. These pliers usually comprise a fixed handle having a fixed jaw on one end thereof. A movable jaw and a movable handle are pivotal relative to the fixed handle to open and close the jaws. To operate the pliers the movable handle is closed relative to the fixed handle to close the fixed jaw and movable jaw and seize a workpiece firmly therebetween. The handles are then tightly compressed such that the toggle mechanism locks the pliers onto the workpiece. The pliers will remain firmly locked in place without the continuous application of force by the user. The pliers may comprise a relatively simple toggle-locking mechanism where a single link has one end pivotably connected to the movable jaw and the opposite end adjustably and pivotably received in the movable handle such as shown in U.S. Pat. No. 4,546,680. The pliers may also comprise a more complex toggle-locking mechanism that uses a compound linkage where multiple links are pivotably connected to one another between the fixed handle and the movable handle such as shown in U.S. Pat. No. 5,056,385. The locking pliers may also comprise self-adjusting pliers such as shown in U.S. Pat. No. 6,941,844. Other embodiments of locking pliers are also known. The jaws may be shaped to function as long nose pliers, ordinary wrenches with curved serrated jaws, jaws in the shape of C-clamps, C-clamps with swivel pads, hole punches, or any other kind of hand tool where the toggle-locking action is useful.

Adjustments in the force applied by the jaws to the workpiece are generally made by turning an adjusting screw mounted in the fixed handle that engages the toggle locking mechanism. The adjusting screw is translated relative to the fixed handle to modify the physical dimensions of the toggle mechanism. Specifically, the adjustment screw contacts the end of the toggle locking mechanism such that as the screw is translated relative to the fixed handle the end of the toggle-locking mechanism is moved relative to the fulcrum point to vary the effective length of the toggle-locking mechanism. This adjustment varies the distance between the jaws and further adjustment of the screw varies the force applied by the jaws to the workpiece when the tool is locked.

Force can be applied to the workpiece via the jaws by turning the adjustment screw in a direction to increase the pressure exerted on the toggle link assembly when the tool is closed whether or not pressure is applied by the jaws to the workpiece when the tool is locked. This adjustment allows the tool to apply and increase the pressure on the workpiece in a very controlled manner such that the workpiece can be compressed, bent or drawn together. By turning the adjustment screw in a direction that lessens the force exerted on the toggle link assembly when the tool is locked, pressure on the workpiece can be eased while the tool is locked on a workpiece such that the tool can be unlocked easily and in a controlled manner. Without the adjusting mechanism, a tool that is locked under high pressure can be difficult to release. The adjustment mechanism also allows the tool to function similarly to a table or bench vise.

The mechanism for applying the rotational force to the adjustment screw may consist of a knurled knob that is intended to be gripped between a user's fingers such that the rotational force is applied to the adjusting screw by hand. As will be appreciated such a configuration is common and is desired by the end user because it allows a fine application of force to be applied by hand and provides the user with direct feedback on the gripping force applied to the workpiece. One problem with such a configuration is that it may be difficult to apply by hand a large torque to the adjustment screw.

In order to allow the user to apply a greater torque to the adjustment screw, it is known to replace the knurled knob with a knob having plural pairs of opposed flat surfaces similar to the exterior surfaces of a nut. Such a configuration allows the adjustment screw to be gripped by a tool such as a box wrench, adjustable wrench or pliers. The use of a wrench or pliers allows the user to apply a much greater torque to the adjustment screw such that the gripping force of the tool is increased. One problem with such an arrangement is that the user looses the “feel” of the knurled knob for making manual adjustments. Another problem is that a conventional wrench or pliers can apply an overload to the adjustment screw and cause a failure of the toggle-locking mechanism or other components of the pliers.

Another mechanism for rotating the adjustment screw comprises a lever or “tommy bar” permanently attached to the adjustment screw. The lever comprises a bar that is slidably received in a bore formed in the adjustment screw head. Typically the lever is formed with enlarged ends that are larger than the diameter of the bore such that the lever is prevented from falling out of the bore and is permanently retained in the screw head. Another similar mechanism employs a lever that is pivotably mounted to the adjustment screw such that it can be flipped open to an operative position. The lever increases the amount of torque that can be applied to the adjustment screw; however, because the lever is permanently attached to the adjustment screw it is a cumbersome design and the lever is often in the way during use of the pliers and adds unwanted size and weight to the tool. The lever also hinders the direct manual application of torque to the adjustment screw. Moreover, if an overload torque is applied to the lever, the lever may fail and bend. While failure of the lever protects the pliers, the functionality of the lever is destroyed.

Thus, an improved adjustment mechanism for a locking pliers is desired.

### SUMMARY OF THE INVENTION

The locking pliers of the invention consists of a first fixed handle connected to a first fixed jaw. A second movable handle and second movable jaw are pivotably connected to the first fixed handle and first fixed jaw such that movement of the movable handle relative to the fixed handle causes the movable and fixed jaws to open and close. A toggle-locking mechanism is provide between the jaws to lock the movable jaw in the closed position relative to the fixed jaw and apply a clamping or gripping force on a workpiece located between he jaws. An adjustment screw is provided on the fixed handle to vary the effective length of the toggle locking mechanism and the distance between the jaws thereby controlling the force applied by the jaws to a workpiece. The adjustment screw consists of a threaded member having a head that has a knurled outer periphery such that it can be manually tightened and loosened and provides the feel and direct feed back of a conventional adjustment screw. A socket is formed in the flat transverse face of the screw head that is disposed along the longitudinal, rotational axis of the screw. The socket has an internal configuration that mates with a torque applying tool such as a hex key or hex key wrench. Specifically, the socket comprises an elongated bore formed with flat faces that matingly engage the flat faces of the hex wrench. The use of the socket allows the device of the invention to have the look and feel of traditional locking pliers while providing the ability to increase or decrease the pressure applied to a workpiece by the jaws in a very controlled and precise manner. The pressure can compress, bend, draw together or separate a workpiece or workpieces. The use of the hex wrench also limits the amount of torque that can be applied to the tool. By selecting the diameter of the socket properly, the hex wrench will fail before the pliers fail.

### BRIEF DESCRIPTION OF THE FIGURES

FIG. 1 is a side view of one embodiment of a locking pliers according to the present invention in the open, unclamped position.

FIG. 2 is a side view of an embodiment of a locking pliers according to the present invention in its closed, locked position.

FIG. 3 is a front view of the adjustment mechanism of an embodiment of the present invention.

FIG. 4 is a perspective view of the adjustment mechanism of an embodiment of the invention.

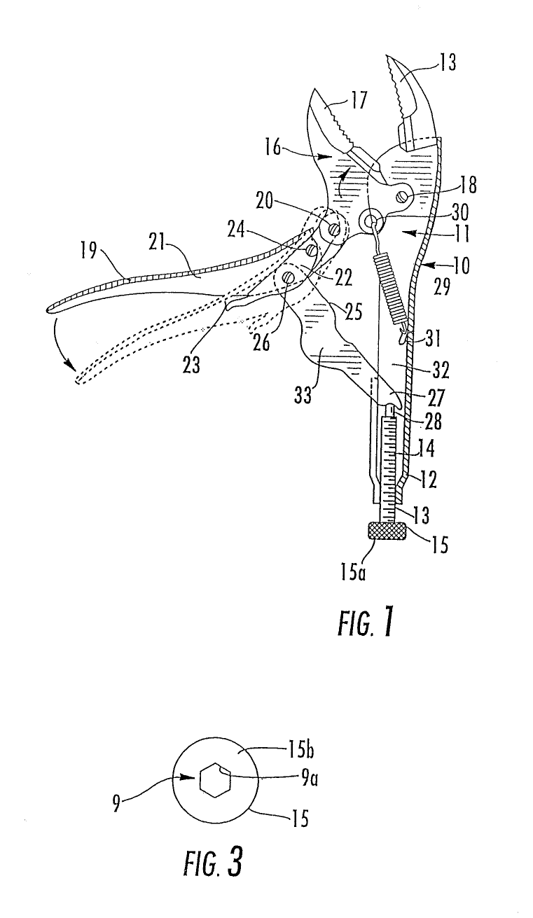

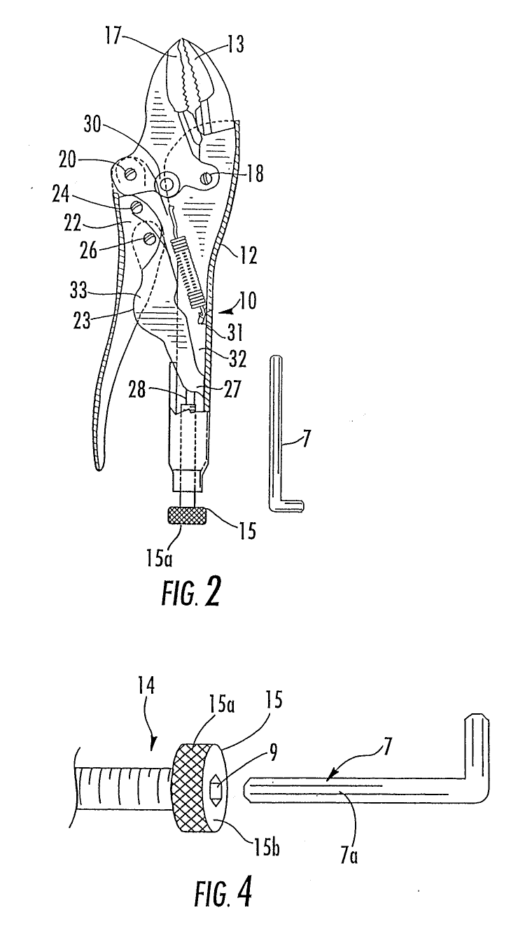

### DESCRIPTION OF PREFERRED EMBODIMENTS

The adjustment mechanism of the invention is intended to be used with any locking pliers that uses an adjustment screw to set the clamping force applied by the jaws to a work piece including simple toggle-locking mechanisms, compound toggle-locking mechanisms and self-adjusting locking pliers. Examples of such locking pliers are provided in the following United States patents, the disclosures of which are incorporated herein by reference. This list is not exhaustive of the styles and types of locking pliers on which the locking mechanism of the invention may be used.

| Inventor | U.S. Pat. No. |
|---|---|
| W. Petersen | 1,489,458 |
| W. Petersen | 2,201,918 |
| W. Petersen | 2,280,005 |
| Borchers | 2,299,454 |
| Toernberg | 2,341,489 |
| W. Petersen | 2,417,013 |
| C. Petersen | 2,563,267 |
| C. Petersen | 2,590,031 |
| W. Petersen | 2,711,663 |
| W. Petersen | 2,853,910 |
| Hostetter | Re. 26,280 |
| C. Petersen et al. | 3,192,804 |
| Schroeder | 3,585,704 |
| Marasco | 3,590,669 |
| Baldwin | 3,600,986 |
| C. Petersen | 4,541,312 |
| C. Petersen | 4,546,680 |
| Petersen | 4,709,601 |
| Petersen | 4,730,524 |
| Petersen | 5,056,385 |
| Leseberg et al. | 5,351,585 |
| Sorensen | 5,377,567 |
| Dahl et al. | 5,456,144 |
| Chervenak et al. | 5,503,049 |
| Peperkorn et al. | 6,626,070 |
| Chervenak | 6,279,433 |
| Hile | 6,941,844 |

For purposes of explaining the construction and operation of the adjustment mechanism of the invention, one such locking pliers will be described in detail with reference to the locking pliers 10 shown in FIGS. 1 and 2. Pliers 10 include a fixed arm 11 having a fixed handle 12 at one end and a fixed jaw 13 at the other end. A movable arm 16 includes a movable handle 19 and a movable jaw 17 which is pivotably connected at one end of the movable handle 19 by the pivot pin 20. A pivot pin 18 connects the movable jaw 17 to the fixed handle 12. A compound link 22 is pivotably connected to the movable handle 19 by a pivot pin 24.

A toggle link 25 spans the distance between the fixed handle 12 and the compound link 22 where the toggle link is pivotably connected by the pivot pin 26. A projection 33 extends transversely to the length direction of the toggle link 25 and acts as a stop when the jaws are in the closed position by making contact with the end 23 of the compound link 22. A biasing spring 29 extends between an opening 30 on the movable jaw 16 to a tab 31 protruding from fixed handle 12. The spring 29 applies a bias which tends to separate the jaws 13, 17, one from the other.

When the jaws 13 and 17 are in the open position shown in FIG. 1, the pivots points, 18, 20, 24, 26, and the pivoting contact between toggle link 25 at its end 27 with the end of the adjusting screw 14, are arranged as a polygon. When the jaws are in the closed position of FIG. 2, the pivot points 20, 24, 26 and the pivoting contact 27, 28 are substantially in a straight line, thus forming a substantially right triangle with the pivot 18. The pins 24, 26 are in an over-center position and can move no closer to the fixed handle 12 because the protrusion 33 presses against the compound link 22 at the end 23.

The jaws 13 and 17 cannot be pried apart from the locked position by use of force which pulls or pushes on the jaws 13, 17, as separation of the jaws is prevented by the over-center condition of the pins 24, 26. However, the jaws 13, 17 may be separated by applying a force to the movable handle 19 in a direction which moves the movable handle 19 away from the fixed handle 12.

It should be further understood that the “over-center” condition of the pivot pins 24, 26, which maintains the jaws in a locked position, should also be construed to include a pin arrangement which lines the pins up on “dead center,” that is, in a straight line. Basically, any configuration of pivot pins and stops, for example, the stop 33, which places the mechanism in a locked position when the jaws are closed or grasping a workpiece, can be considered an over-center mechanism when force applied directly to the jaws to separate the jaws is not effective in moving the jaws. The jaws can only be opened by forces acting on the links of the mechanism.

The end of the fixed handle 12, remote from the jaw 13, is completed with a threaded circular aperture 13 through which a threaded adjustment screw 14 is threadably engaged. The screw 14 terminates in an adjusting knob or head 15. The end 27 of the toggle link 25 is slidably and pivotably engaged with the end 28 of the adjusting screw 14. As is apparent from the drawing, turning the adjusting screw 14 changes the distance between the end 27 of the toggle link 25 and the pivot point 18 of the movable jaw 16, whereby the jaws may be adjusted to grip objects of different dimensions with varying force.

The adjusting head 15 has an outer peripheral surface 15a that is knurled and can be gripped by the user's hand to manually rotate the adjustment screw 14. Manual rotation is used herein to refer to the direct application of force to the adjustment screw by hand without the use of any additional mechanical advantage. The head 15 with knurled surface 15a is similar to traditional locking pliers such that the look and feel of the pliers is familiar to the user and simple and easy to use.

The adjusting head 15 includes a transverse surface 15b that is substantially perpendicular to the direction of travel of the screw 14. Formed in head 15 is an internal socket 9 that extends from surface 15b into the head 15 along the rotational axis of screw 14. Socket 9 is shaped and dimensioned to receive a torque applying tool or driver for rotating the screw relative to the handle. In one embodiment the socket 9 includes flat internal faces 9a that are dimensioned and arranged to mate with corresponding external faces 7a on a driver such as a hex key wrench 7. Hex key wrench 7 is also known as a hex key, hex wrench or Allen wrench and typically comprises an L-shaped wrench fabricated from hexagonal wire stock of various sizes, used to turn screw or bolt heads designed with a hexagonal recess. An alternative torque producing driver may be a hex socket driver. In one embodiment the socket 9 is formed of a hexagonal cross-section such that it closely engages the hex key wrench 7. While specific reference has been made to a hex key wrench and a mating hex shaped socket 9, it is to be understood that socket 9 may be designed to matingly engage a torque producing driver such as a TORX driver or a ROBERTSON driver where the internal shape of the socket may have a mating star or square shape.

The hex key wrench 7 can be inserted into socket 9 to rotate the screw 14 to increase or decrease the space between the jaws 13 and 17 and thereby control the force applied by the jaws to the workpiece. When not in use the hex key wrench is removed from socket 9 such that it is not in the way of the user during use of the tool or when direct manual adjustment of screw 14 is made. By using a socket 9 that is dimensioned to receive a maximum size of hex key wrench 7, the hex key wrench 7 limits the amount of torque that can be applied to the adjustment screw 14 thereby protecting the pliers' components against failure due to over tightening of the adjustment screw 14.

The use of the hex socket 9 provides a locking pliers that looks, feels and operates the same as a traditional tool that does not provide for the use of a mechanical advantage to increase torque on screw 14. This is an advantage for the end user because the end user can apply torque manually in the known manner with the same direct feed back and comfort and none of the disadvantages of the tommy bar, flip handle or hex headed adjustment screw as previously described. Moreover, the hex socket allows the application of increased torque using the mechanical advantage of a hex key wrench. The use of the hex key wrench protects the tool from damage due to overloading the adjustment screw because the maximum torque that can be applied to the tool is limited by the size of the hex key wrench. The manufacturer can control the size of the hex key wrench used by the end user by controling the size of the socket. This is not possible with adjustment screws that use an adjustment screw with flat faces that may be torqued by standard box wrenches, adjustable wrenches or pliers, because these wrenches are designed to apply a much greater force than the standard locking pliers is able to withstand. The use of the hex socket also protects the contact surfaces 9a of the socket 9 from damage from external sources during use of the tool. Finally, the socket size can be dimensioned to fit any locking pliers including very small pliers while controling the amount of torque applied and minimizing the size of the screw head 15.

Specific embodiments of an invention are disclosed herein. One of ordinary skill in the art will recognize that the invention has other applications in other environments. Many embodiments are possible. The following claims are in no way intended to limit the scope of the invention to the specific embodiments described above.

What is claimed is:

1. A lockable pliers comprising:
a first handle supporting a first jaw;
a second handle movable relative to the first handle between an open position and a closed position;
a second jaw movable between a first position when said second handle is in said open position and a second position when said second handle is in said closed position;
a toggle-link locking mechanism having an effective length for locking the second jaw in the second position; and
an adjustment screw for adjusting the effective length of the toggle-link locking mechanism, said adjustment screw including a socket for receiving a tool for turning the adjustment screw. wherein said adjustment screw rotates about an axis and said socket is axially aligned with the axis; said socket being exposed during use of the pliers such that the socket may be accessed during use of the pliers to adjust the effective length of said toggle locking mechanism.

2. (canceled)

3. The locking pliers of claim 1 wherein the socket includes faces extending parallel to the axis, said faces engaging the tool such that the tool rotates the adjustment screw.

4. The locking pliers of claim 1 wherein said socket is hexagonal.

5. The locking pliers of claim 1 wherein the size of the socket is selected based on a desired maximum torque to be applied to the adjustment screw.

6. The locking pliers of claim 1 wherein the adjustment screw includes a knurled outer surface.

7. The locking pliers of claim 1 wherein the knurled outer surface is uninterrupted by said socket.

8. A locking pliers and hex key wrench kit comprising:
a first handle supporting a first jaw;
a second handle movable relative to the first handle between an open position and a closed position;
a second jaw movable between a first position when said second handle is in said open position and a second position when said second handle is in said closed position;
a toggle-link locking mechanism having an effective length for locking the second jaw in the second position;
an adjustment screw for adjusting the effective length of the toggle-link locking mechanism, said adjustment screw including a socket for receiving a tool for turning the adjustment screw, and wherein said adjustment screw rotates about an axis and said socket is axially aligned with the axis; said socket being exposed during use of the pliers such that the socket may be accessed during use of the pliers to adjust the effective length of said toggle locking mechanism, and
a wrench engageable with said socket.

9. The locking pliers of claim 8 wherein said wrench is dimensioned such that upon the application of a predetermined force the wrench fails before the pliers fails.

10. A method of gripping a workpiece with a locking pliers comprising:
providing a first handle supporting a first jaw;
providing a second handle movable relative to the first handle between an open position and a closed position;
providing a second jaw movable between a first position when said second handle is in said open position and a second position when said second handle is in said closed position;
providing a toggle-link locking mechanism having an effective length for locking the second jaw in the second position;
providing an adjustment screw for adjusting the effective length of the toggle-link locking mechanism, said adjustment screw including a socket for receiving a driver for turning the adjustment screw; wherein said adjustment screw rotates about an axis and said socket is axially aligned with the axis; said socket being exposed during use of the pliers such that the socket may be accessed during use of the pliers to adjust the effective length of said toggle locking mechanism;
inserting the driver into said socket; and
turning said adjustment screw with said driver.
